(19) United States
(12) Patent Application Publication
(10) Pub. No.: US 2026/0109330 A1
(43) Pub. Date: Apr. 23, 2026

(54) METHOD FOR LATERALLY STABILIZING AGRICULTURAL VEHICLE COMBINATION

(71) Applicant: Deere & Company, Moline, IL (US)

(72) Inventors: NORBERT FRITZ, ILVESHEIM (DE); JULIAN BAUMANN, Karlsruhe (DE)

(21) Appl. No.: 19/350,134

(22) Filed: Oct. 6, 2025

(30) Foreign Application Priority Data
Oct. 23, 2024 (EP) 24208404.4
Jan. 13, 2025 (EP) 25151475.8

(51) Int. Cl. B60T 8/17; B60T 8/1755

(52) U.S. Cl. CPC B60T 8/1708; B60T 8/17551; B60T 2230/02; B60T 2230/06; B60T 2250/03

(57) ABSTRACT

A method for laterally stabilizing an agricultural vehicle combination comprises determining, by a control unit, an actual value of a yaw rate variable characterizing a yaw rate of the agricultural tractor by a sensor array assigned to the agricultural tractor and comparing the actual value of the yaw rate variable with a target value specified for the yaw rate variable for identifying an oversteer or understeer tendency of the agricultural tractor. The control unit, upon identification of an oversteer tendency of the agricultural tractor arising in trailer operation, concludes that this is a forced articulation angle increase caused by thrust, or upon identification of an understeer tendency of the agricultural tractor arising in trailer operation, concludes that this is a retarded articulation angle reduction caused by thrust, and at least partially compensates for this by driver-independent intervention in wheel braking devices of the trailer.

### CROSS-REFERENCE TO RELATED APPLICATIONS

This application claims priority to European Patent Application No. 25151475.8, filed Jan. 13, 2025 and European Patent Application No. 24208404.4, filed Oct. 23, 2024, which are hereby incorporated by reference.

### TECHNICAL FIELD

The present disclosure relates generally to a method for laterally stabilizing an agricultural vehicle combination including a towing vehicle in the form of an agricultural tractor and a trailer attached thereto.

### BACKGROUND

A method for stabilizing a vehicle combination including a towing vehicle and a trailer is derived from DE 198 59 953 A1, in which method in the context of driving dynamics control, laterally stabilizing braking interventions are carried out on the towing vehicle as a function of, inter alia, a deviation occurring between a target value and an actual value of a yaw rate of the towing vehicle. The target value for the yaw rate is determined using a vehicle model, which includes, for example, the vehicle speed and a steering angle set for the towing vehicle. In this context, only indirect and therefore insufficient account is taken of a proportion of the yawing behavior attributable to the trailer.

### SUMMARY

It is therefore the object of the present disclosure to refine a method of the type mentioned at the outset in such a way that a proportion of a trailer attached to the towing vehicle, or to the agricultural tractor, that can be attributed to an identified oversteer or understeer tendency of the latter is correspondingly taken into account with a view to improved lateral stabilizing.

This object is achieved by a method for laterally stabilizing an agricultural vehicle combination, having the features of one or more embodiments disclosed herein.

The method according to the disclosure for laterally stabilizing an agricultural vehicle combination including a towing vehicle in the form of an agricultural tractor and a trailer attached thereto provides that an actual value of a yaw rate variable characterizing a yaw rate of the agricultural tractor is determined by a control unit by a sensor array assigned to the agricultural tractor, and is compared with a target value specified for the yaw rate variable for the purpose of identifying an oversteer or understeer tendency of the agricultural tractor, wherein the specification of the target value by the control unit takes place so as to correspond to a yaw behavior to be expected due to the steering angle and the traveling speed of the agricultural tractor. In the process, the control unit, upon identification of an oversteer tendency of the agricultural tractor arising in trailer operation, concludes that this is a forced articulation angle increase caused by thrust, or upon identification of an understeer tendency of the agricultural tractor arising in trailer operation, concludes that this is a retarded articulation angle reduction caused by thrust, and at least partially compensates for this by driver-independent intervention in wheel braking devices only of the trailer.

The disclosure is based on the concept that in agricultural tractors, in view of the comparatively low traveling speeds of no more than 60 km/h in road traffic, oversteer or understeer is usually caused by thrust forces caused by a trailer attached to a towing coupling of the agricultural tractor via a drawbar. At such traveling speeds, transverse dynamic effects, such as those that can occur in motor trucks when driving through bends at excessive speed, are largely irrelevant.

Accordingly, the thrust forces exerted on the rear of the tractor by the trailer, should the steering angle and the articulation angle be oriented in the same direction (i.e. the drawbar position corresponds to the profile of the curve of the agricultural tractor determined by the steering angle), tend to cause the agricultural tractor to oversteer, because the rear of the tractor is pushed toward the outside of the curve via the towing coupling. This typically results in a more or less leading, and thus “forced”, increase in the articulation angle between the agricultural tractor and the trailer, i.e. the angle that is enclosed between the longitudinal axis of the agricultural tractor and the longitudinal axis of the trailer.

In contrast, if the steering angle and the articulation angle are oriented in opposite directions (i.e. the drawbar position does not correspond to the profile of the curve of the agricultural tractor determined by the steering angle), the thrust forces exerted by the trailer on the rear of the tractor tend to cause the agricultural tractor to understeer, because the rear of the tractor is pushed toward the inside of the curve via the towing coupling. This results in a more or less trailing, thus “retarded” reduction in the articulation angle between the agricultural tractor and the trailer.

Both driving situations result in a yaw rotation about the vertical axis of the agricultural tractor, which is noticeable at a corresponding yaw rate, in each case in a different direction. Accordingly, the control unit concludes that this is a tendency of the agricultural tractor to oversteer or understeer when the actual value of the yaw rate variable exceeds or falls below the target value of the yaw rate variable.

An additional indication as to whether such a behavior is due to thrust results from the respective directions of steering angle and articulation angle relative to one another. Thus, there is the possibility that the control unit assumes a forced articulation angle increase caused by thrust, or a retarded articulation angle reduction caused by thrust, only if it is derived based on a comparison of the algebraic signs of the steering angle and the articulation angle that these point in the same direction, or in opposite directions, respectively.

The susceptibility of an agricultural vehicle combination to the occurrence of such instability depends, among other things, on the traction and/or mass ratios of the agricultural tractor and trailer.

If an oversteer or understeer tendency of the agricultural tractor is detected under such conditions, it is possible to achieve a laterally stabilizing reduction in the articulation angle by sufficiently decelerating the trailer. This is in visual terms performed by “straightening” the agricultural vehicle combination. Accordingly, ineffective braking interventions on the towing vehicle, as provided in the state of the art, are not performed.

The target value of the yaw rate variable can be determined by the control unit based on the steering angle and the traveling speed of the agricultural tractor, for example, on the basis of a so-called linear single-track model. Assuming a standardized drawbar length, it is also possible to make a statement regarding the algebraic sign and approximate value of the articulation angle Alternatively, immediate sensory detection of the latter by a rotation angle sensor or the like assigned to the towing coupling is conceivable.

Advantageous refinements of the method according to the disclosure for laterally stabilizing an agricultural vehicle combination can be derived from the one or more embodiments disclosed herein.

In order to ensure that driver-independent intervention in the wheel braking devices of the trailer is restricted to the driving situations described at the outset, it can be provided that the control unit assumes a forced articulation angle increase caused by thrust, or assumes a retarded articulation angle reduction caused by thrust, only when an activation of a service braking system of the agricultural tractor and trailer, of a retarder on the tractor and/or downhill travel of the agricultural vehicle combination are/is simultaneously identified. In all these cases, increased pushing by the trailer can occur. Thus, when the retarder is used, i.e. when the agricultural tractor is being “engine-braked”, the agricultural tractor decelerates relative to the trailer attached thereto. This causes the trailer to overrun, which also applies when thrust forces occur due to the gradient when traveling downhill. It moreover also takes into account situations in which both the agricultural tractor and the trailer are decelerated by the driver activating an associated service brake system, but due to a degradation of the braking performance of the wheel braking devices on the trailer (for example due to wear or insufficient brake pressure) the braking deceleration of the latter is less than that of the agricultural tractor.

The identification of downhill travel by the control unit can take place based on an inclination angle variable which is determined by a further sensor array and reflects an inclination of the agricultural tractor about its transverse axis, and/or by GPS-based evaluation of topographical data. The topographical data stored in a storage unit allows a conclusion to be drawn on the terrain profile along the distance traveled or to be traveled by the agricultural tractor, wherein this topographical data is located using information pertaining to the current position of the agricultural tractor for the purpose of the GPS-based evaluation. That information is provided by a GPS navigation system connected to the control unit.

Since a thrust force exerted on the towing coupling by the trailer in the case of a substantially elongate agricultural vehicle combination does not per se lead to oversteer or understeer of the agricultural tractor, it is moreover conceivable that carrying out a driver-independent intervention in the wheel braking devices of the trailer by the control unit takes place under the proviso that the value of the articulation angle between the agricultural tractor and the trailer exceeds a predefined threshold.

Furthermore, it is possible that for the predictive and therefore early identification of an expected oversteer or understeer tendency of the agricultural tractor by the control unit a temporal increase of a deviation resulting from the comparison of the target value and actual value of the yaw rate variable is evaluated. This makes it possible to assess the likely profile of an oversteer or understeer tendency of the agricultural tractor, and to effectively counteract a thrust-related influence on the articulation angle by early intervention in the wheel braking devices of the trailer.

The latter is supported in that the control unit, upon identification of an expected oversteer or understeer tendency of the agricultural tractor, preloads the wheel braking devices of the trailer to a defined grinding point. As a result, further improved response times can be achieved when carrying out the articulation angle-reducing interventions in the wheel braking devices of the trailer. In the case of hydraulic or pneumatic activation of the wheel braking devices, this can be performed by pre-filling associated brake cylinders.

The steering angle can be derived by the control unit on the basis of a steering angle variable detected by a steering angle sensor, which reflects a wheel steering angle set at steerable wheels of the agricultural tractor, or an unequivocally related substitute variable. The latter can be, for example, a deflection occurring on a steering cylinder.

Other features and aspects will become apparent by consideration of the detailed description, claims, and accompanying drawings.

### BRIEF DESCRIPTION OF THE DRAWINGS

The method according to the disclosure for laterally stabilizing an agricultural vehicle combination will be explained in more detail hereunder by the appended drawings. Identical components, or components which are comparable in terms of their function, are denoted by the same reference signs.

FIG. 1 shows an example embodiment of the method according to the disclosure, visualized as a flow chart, for laterally stabilizing an agricultural vehicle combination.

FIG. 2 shows a schematically illustrated example embodiment of a device for carrying out the method according to the disclosure illustrated in FIG. 1.

FIG. 3 shows a first driving situation leading to thrust-induced oversteer of the agricultural tractor.

FIG. 4 shows a second driving situation leading to thrust-induced understeer of the agricultural tractor.

Like reference numerals are used to indicate like elements throughout the several figures.

### DETAILED DESCRIPTION

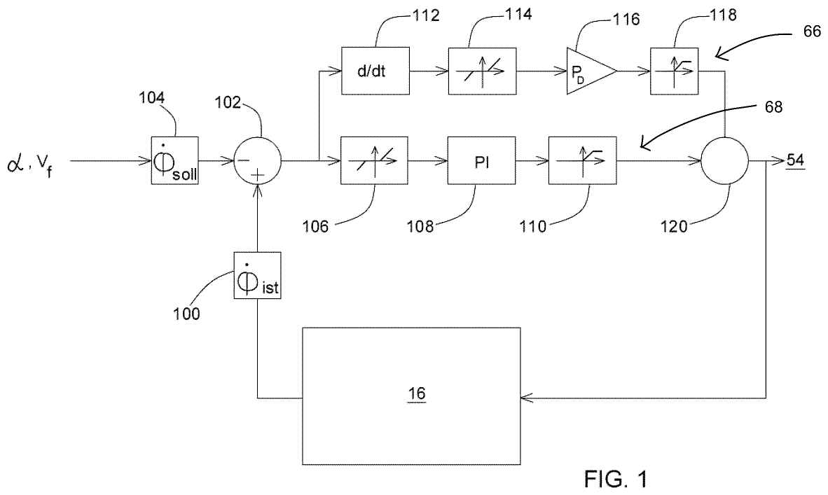

FIG. 1 shows an example embodiment of the method according to the disclosure, visualized as a flow chart, for laterally stabilizing an agricultural vehicle combination.

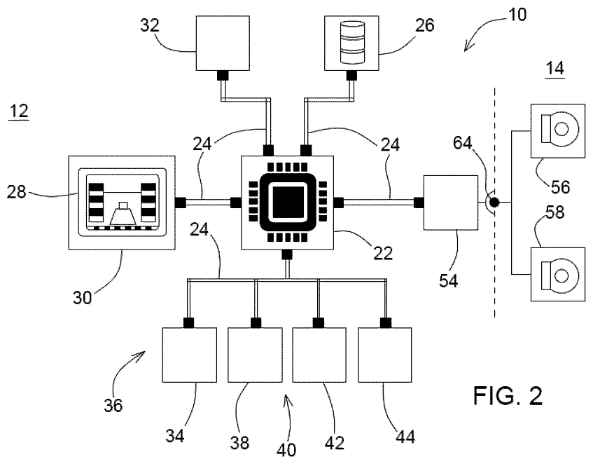

First, the device 10, corresponding to FIG. 2, for carrying out the method is to be discussed, in which an agricultural vehicle combination 16 including an agricultural tractor 12 and a trailer 14 attached thereto is illustrated, wherein the trailer 14 is attached to a trailer coupling 20 of the agricultural tractor 12 via a drawbar 18. The trailer coupling 20 is, for example, a clevis or a ball coupling.

The device 10 assigned to the agricultural tractor 12 comprises a microprocessor-controlled control unit 22, which is connected via a BUS system 24 to a storage unit 26, a graphic user interface 30 formed as a touch-sensitive display 28, a GPS navigation system 32, a first sensor array 36 formed as a yaw rate sensor 34, a second sensor array 40 formed as a tilt sensor 38, a steering angle sensor 42, and a plurality of wheel speed sensors 44 for detecting wheel speeds occurring on associated wheels 46, 48, 50, 52 of the agricultural tractor 12.

A brake control unit 54 on the tractor also allows a hydraulic or pneumatic activation of left and right wheel braking devices 56, 58 of the trailer 14 for braking associated wheels 60, 62, wherein the wheel braking devices 56, 58 are connected to the brake control unit 54 on the tractor via a pressure coupler 64. It should be noted that, contrary to the illustration, it may also be a multi-axle trailer, in particular also with a steered drawbar.

The control unit 22 is part of a control unit architecture not illustrated in more detail of the agricultural tractor 12 and can serve to carry out further functions for driving dynamics control, such as for implementing an ABS system or the like.

With reference to the block diagram reproduced in FIG. 1, the method carried out by the control unit 22 and stored as a corresponding program code in the memory unit 26 comprises two coordinate control loops 66, 68.

The assistance function implemented by the method according to the disclosure in the case of trailer operation is activated via the graphical user interface 30 by the driver, or automatically when an ISOBUS connection between the trailer 14 and the agricultural tractor 12 is established.

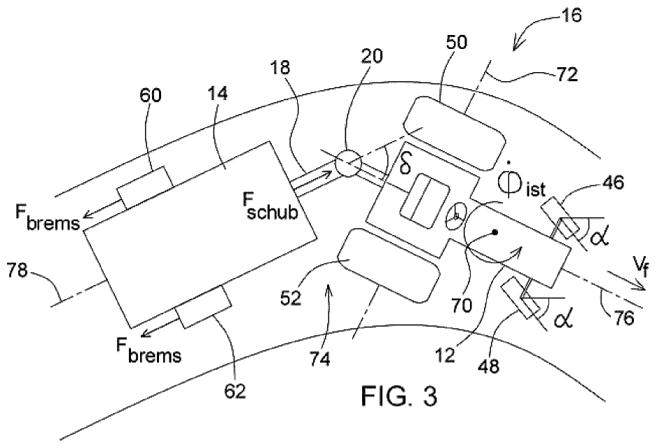

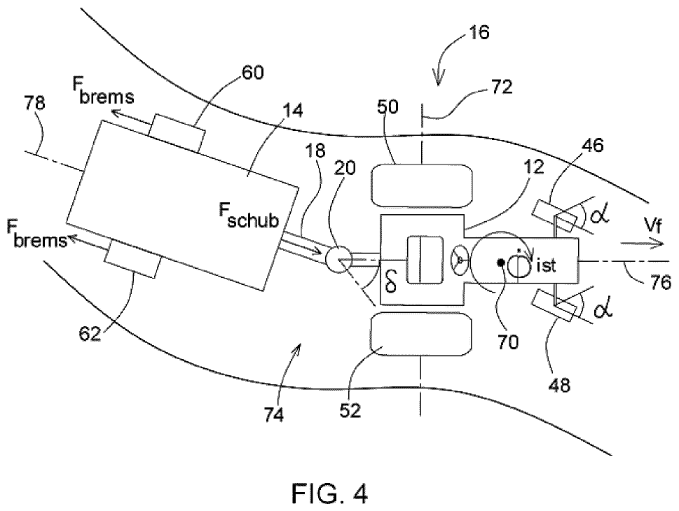

First, in a first function block 100, an actual value \dot{φ}ᵢₛₜ of a yaw rate variable characterizing a yaw rate of the agricultural tractor 12 is determined by the control unit 22 by the first sensor array 36, or the yaw rate sensor 34, and, in a second function block 102, for identifying an oversteer or understeer tendency of the agricultural tractor 12 is compared with a target value \dot{φ}ₛₒᵢₗ, predefined in a third function block 104, for the yaw rate variable. The specification of the target value \dot{φ}ₛₒᵢₗ by the control unit 22 in the third function block 104 take place so as to correspond to a yaw behavior to be expected due to steering angle α and traveling speed v_{f} of the agricultural tractor 12 and is determined by the control unit 22 based on a so-called linear single-track model. The yaw rate refers to the temporal change or speed of a rotation occurring about the vertical axis 70 of the agricultural tractor 12 (cf. FIG. 3 or 4). Assuming a standardized drawbar length, the control unit 22 furthermore determines the approximate value and the algebraic sign of an articulation angle δ enclosed between the longitudinal axis 76 of the agricultural tractor 12 and the longitudinal axis 78 of the trailer 14.

The steering angle α included in the linear single-track model is derived by the control unit 22 on the basis of a steering angle variable detected by the steering angle sensor 42, which reflects a wheel steering angle set at the steerable wheels 46, 48 of the agricultural tractor 12, or an unequivocally related substitute variable. The latter is, for example, a deflection occurring on a steering cylinder. The traveling speed vi of the agricultural tractor 12, which is also included in the linear single-track model, results from the wheel speeds detected by the wheel speed sensors 44.

Target value \dot{φ}ₛₒᵢₗ and actual value \dot{φ}ᵢₛₜ form input variables for the second function block 102, in which their values are compared with each other by the control unit 22 so as to determine a control deviation that occurs between them by forming a difference.

An oversteer tendency of the agricultural tractor 12 is to be assumed if the difference between the value of the actual value \dot{φ}ᵢₛₜ and the value of the target value \dot{φ}ₛₒᵢₗ of the yaw rate variable is greater than zero,

$$\vert {ϕ}_{ist} \vert > \vert {ϕ}_{target} \vert ,$$

whereas an understeer tendency of the agricultural tractor 12 is to be assumed if the difference between the value of the actual value \dot{φ}ᵢₛₜ and the value of the target value \dot{φ}ₛₒᵢₗ of the yaw rate variable is less than zero,

$$\vert {ϕ}_{ist} \vert < \vert {ϕ}_{target} \vert .$$

Both driving situations result in a yaw rotation about the vertical axis of the agricultural tractor, which is noticeable at a corresponding yaw rate, in each case in a different direction.

The value of the control deviation determined in each case forms the basis both for the first closed control loop 66 for yaw rate control and for the second closed control loop 68 for yaw acceleration control.

On the one hand, the determined control deviation first passes through a fourth function block 106, in which a dead band is set, control deviations lying within the latter being hidden for a PI controller (proportional integral controller) provided in a fifth function block 108. In a sixth function block 110, a possible saturation is suppressed using an appropriate anti-windup method. This takes into account the case that the control variable present at the output of the PI controller is outside the range of the following brake control unit 54, or the wheel braking devices 56, 58 on the trailer to be activated therewith.

On the other hand, the determined control deviation passes through a seventh function block 112, in which the temporal derivation of the determined control deviation is formed. Here, too, a dead band is set in an eighth function block 114, temporal changes of the control deviation lying within the latter being hidden for a GAIN amplifier provided in a ninth function block 116. In a tenth function block 118, a possible saturation of the control variable provided at the output of the GAIN amplifier is again suppressed using an appropriate anti-windup method.

The control variables present on the output side of the sixth function block 110 and tenth function block 118 are combined or superimposed by the control unit 22 in an eleventh function block 120, and transmitted to the brake control unit 54 for the purpose of corresponding activation of the wheel braking devices 56, 58 on the trailer.

For further explanation of the functionality of the method according to the disclosure, reference is made to the driving situations illustrated in FIGS. 3 and 4 respectively. These show the agricultural vehicle combination 16 including the agricultural tractor 12 and the trailer 14 when traveling through a U or S curve under the effect of a thrust force F_{schub} exerted by the trailer 14 on the agricultural tractor 12.

According to the first driving situation of the agricultural vehicle combination 16 shown in FIG. 3, the thrust forces F_{schub} exerted on the rear of the tractor 74 by the trailer 14 when traveling through a U-curve if steering angle α and articulation angle δ are oriented in the same direction (i.e. the drawbar position corresponds to the profile of the curve of the agricultural tractor 12 determined by the steering angle α) tend to cause the agricultural tractor 12 to oversteer, since the rear of the tractor 74 is pushed toward the outside of the curve via the towing coupling 20. This typically results in a more or less leading, thus “forced”, increase in the articulation angle δ between the agricultural tractor 12 and the trailer 14.

The second driving situation reflected in FIG. 4 shows the agricultural vehicle combination 16 when traveling through an S-curve, wherein the steering angle α and the articulation angle δ are oriented in opposite directions (i.e. the drawbar position does not correspond to the profile of the curve of the agricultural tractor 12 determined by the steering angle α). The thrust forces F_{schub} exerted on the rear of the tractor 74 by the trailer 14 tend to cause the agricultural tractor 12 to understeer, since the rear of the tractor 74 is pushed toward the inside of the curve via the trailer coupling 20. This results in a more or less trailing, thus “retarded”, reduction in the articulation angle θ between the agricultural tractor 12 and the trailer 14.

This results in a corresponding rotation around the vertical axis 70 of the agricultural tractor 12 in the form of a yaw, which is noticeable in a corresponding yaw rate. The susceptibility of the agricultural vehicle combination 16 to the occurrence of such instabilities depends, among other things, on the traction and/or mass ratios of the agricultural tractor 12 and the trailer 14.

Various causes are possible for the occurrence of the thrust forces F_{schub} reproduced in FIGS. 3 and 4 respectively. Thus, when the retarder is used, i.e. when the agricultural tractor 12 is being “engine-braked”, the agricultural tractor 12 decelerates relative to the trailer 14 attached thereto. This will cause the trailer 14 to overrun. The same applies in the case of thrust forces F_{schub} occurring due to the gradient when traveling downhill, or in cases where both the agricultural tractor 12 and the trailer 14 are decelerated by the driver activating an associated service brake system, but due to a degradation of the braking performance of the wheel braking devices 56, 58 on the trailer 14 (for example, due to wear or insufficient brake pressure), braking deceleration is less in comparison to the agricultural tractor 12.

According to the example, the performance of the assistance function is restricted to these cases, the control unit 22 therefore assumes a forced articulation angle increase caused by thrust, or assumes a retarded articulation angle reduction caused by thrust, only when an activation of a service braking system of the agricultural tractor 12 and trailer 14, of a retarder on the tractor and/or downhill travel of the agricultural vehicle combination 16 are/is simultaneously identified.

The identification of downhill travel is carried out by the control unit 22 on the basis of a tilt angle variable determined by the second sensor array 40, or the tilt sensor 38. The determined tilt angle variable represents tilting of the agricultural tractor 12 about its transverse axis 72. Additionally or alternatively, a GPS-based evaluation of topographical data is provided. The topographical data stored in the storage unit 26 allows a conclusion to be drawn on the terrain profile along the distance traveled or to be traveled by the agricultural tractor 12, wherein this topographical data is located using information pertaining to the current position of the agricultural tractor 12 for the purpose of the GPS-based evaluation. That information is provided by the GPS navigation system 32, which is connected to the control unit 22.

Besides the presence of a piece of accessory equipment 14, the control unit 22 receives an additional indication as to whether a behavior of this type is caused by thrust, thus can be traced back to thrust forces F_{schub} which are caused by the trailer 14 that is attached to the towing coupling 20 of the agricultural tractor 12 via the drawbar 18, from the respective directions of the steering angle α and articulation angle δ relative to one another. Thus, the control unit 22 assumes a forced articulation angle increase caused by thrust, or a retarded articulation angle reduction caused by thrust, only when a comparison of the algebraic signs of the steering angle α and the articulation angle δ reveals that they point in the same direction or in opposite directions, corresponding to the two driving situations reflected in FIGS. 3 and 4 respectively.

Since a thrust force F_{schub} exerted by the trailer 14 on the towing coupling 20 does not cause the agricultural tractor 12 to oversteer or understeer per se in the case of a substantially elongate agricultural vehicle combination 16, it is also provided that carrying out a driver-independent intervention in the wheel braking devices 56, 58 of the trailer 14 by the control unit 22 takes place under the proviso that the value of the articulation angle δ between the agricultural tractor 12 and the trailer 14 exceeds a predefined threshold δₘᵢₙ in the range of a few degrees.

If under the conditions described above, proceeding from a control deviation determined in the second function block 102, upon identification of an oversteer or understeer tendency of the agricultural tractor 12 occurring in trailer operation, it is concluded that this is a forced articulation angle increase caused by thrust, or a retarded articulation angle reduction caused by thrust, this is reduced in a targeted manner by driver-independent intervention in the wheel braking devices 56, 58 only of the trailer 14, the objective being to at least partially compensate for them. By sufficiently decelerating the trailer 14, a laterally stabilizing reduction of the articulation angle is in each case achieved in this way. This is in visual terms performed under the effect of the braking force F_{brems}, which is opposed to the thrust force F_{schub}, by “straightening” the agricultural vehicle combination 16.

The second closed control loop 68 is used for predictive and therefore early identification of an expected oversteer or understeer tendency of the agricultural tractor 12. For this purpose, a temporal increase of the control deviation resulting from the comparison of the target value \dot{φ}ₛₒᵢₗ and the actual value \dot{φ}ᵢₛₜ of the yaw rate variable, which is derived in the seventh function block 112, is evaluated by the control unit 22. This makes it possible to assess the likely profile of an oversteer or understeer tendency of the agricultural tractor 12, and to effectively counteract a thrust-related influence on the articulation angle δ by early intervention in the wheel braking devices 56, 58 of the trailer 14.

This is supported in that the control unit 22 preloads the wheel braking devices 56, 58 of the trailer 14 to a defined grinding point. As a result, further improved response times can be achieved when carrying out the articulation angle-reducing interventions in the wheel braking devices 56, 58 of the trailer 14. If hydraulic or pneumatic activation of the wheel braking devices 56, 58 is provided as is the case here, this can be performed by pre-filling associated brake cylinders.

The operating mode of the method according to the disclosure is based on the concept that in agricultural tractors, in view of the comparatively low traveling speeds of no more than 60 km/h in road traffic, oversteering or pulling of the rear of the tractor 74 is typically caused by thrust forces F_{schub} caused by the trailer 14 attached to the towing coupling 20 of the agricultural tractor 12 via the drawbar 18. At such traveling speeds, transverse dynamic effects, such as those that can occur in motor trucks when driving through bends at excessive speed, are largely irrelevant.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for laterally stabilizing an agricultural vehicle combination including an agricultural tractor and a trailer attached thereto, the method comprising:
determining, by a control unit, an actual value of a yaw rate variable characterizing a yaw rate of the agricultural tractor by a sensor array assigned to the agricultural tractor, and
comparing the actual value of the yaw rate variable with a target value specified for the yaw rate variable for identifying an oversteer or understeer tendency of the agricultural tractor,
wherein the specification of the target value by the control unit takes place so as to correspond to a yaw behavior to be expected due to the steering angle and the traveling speed of the agricultural tractor,
wherein the control unit, upon identification of an oversteer tendency of the agricultural tractor arising in trailer operation, concludes that this is a forced articulation angle increase caused by thrust, or upon identification of an understeer tendency of the agricultural tractor arising in trailer operation, concludes that this is a retarded articulation angle reduction caused by thrust, and at least partially compensates for this by driver-independent intervention in wheel braking devices of the trailer.

2. The method of claim 1, wherein the control unit assumes a forced articulation angle increase caused by thrust, or assumes a retarded articulation angle reduction caused by thrust, when an activation of a service braking system of the agricultural tractor and trailer of a retarder on the tractor or downhill travel of the agricultural vehicle combination is simultaneously identified.

3. The method of claim 2, wherein the identification of downhill travel by the control unit takes place based on an inclination angle variable which is determined by a further sensor array and reflects an inclination of the agricultural tractor about its transverse axis or based on GPS-based evaluation of topographical data.

4. The method of claim 1, wherein driver-independent intervention in the wheel braking devices of the trailer by the control unit takes place under the proviso that the value of the articulation angle between the agricultural tractor and the trailer exceeds a predefined threshold.

5. The method of claim 1, wherein for the predictive identification of an expected oversteer or understeer tendency of the agricultural tractor by the control unit, a temporal increase of a deviation resulting from the comparison of the target value and actual value of the yaw rate variable is evaluated.

6. The method of claim 5, wherein the control unit, upon identification of an expected oversteer or understeer tendency of the agricultural tractor, preloads the wheel braking devices of the trailer to a defined grinding point.

7. The method of claim 1, wherein the steering angle is derived by the control unit on the basis of a steering angle variable detected by a steering angle sensor, which reflects a wheel steering angle set at steerable wheels of the agricultural tractor or an unequivocally related substitute variable.

8. An agricultural vehicle combination including an agricultural tractor and a trailer attached thereto, comprising:
a sensor array assigned to the agricultural tractor, and
a control unit configured to receive signals from the sensor array, to determine an actual value of a yaw rate variable characterizing a yaw rate of the agricultural tractor, and to compare the actual value of the yaw rate variable with a target value specified for the yaw rate variable for identifying an oversteer or understeer tendency of the agricultural tractor,
wherein the specification of the target value by the control unit takes place so as to correspond to a yaw behavior to be expected due to the steering angle and the traveling speed of the agricultural tractor,
wherein the control unit, upon identification of an oversteer tendency of the agricultural tractor arising in trailer operation, concludes that this is a forced articulation angle increase caused by thrust, or upon identification of an understeer tendency of the agricultural tractor arising in trailer operation, concludes that this is a retarded articulation angle reduction caused by thrust, and at least partially compensates for this by driver-independent intervention in wheel braking devices of the trailer.

9. The agricultural vehicle combination of claim 8, wherein the control unit assumes a forced articulation angle increase caused by thrust, or assumes a retarded articulation angle reduction caused by thrust, when an activation of a service braking system of the agricultural tractor and trailer of a retarder on the tractor or downhill travel of the agricultural vehicle combination is simultaneously identified.

10. The agricultural vehicle combination of claim 9, wherein the identification of downhill travel by the control unit takes place based on an inclination angle variable which is determined by a further sensor array and reflects an inclination of the agricultural tractor about its transverse axis or based on GPS-based evaluation of topographical data.

11. The agricultural vehicle combination of claim 8, wherein driver-independent intervention in the wheel braking devices of the trailer by the control unit takes place under the proviso that the value of the articulation angle between the agricultural tractor and the trailer exceeds a predefined threshold.

12. The agricultural vehicle combination of claim 8, wherein for the predictive identification of an expected oversteer or understeer tendency of the agricultural tractor by the control unit, a temporal increase of a deviation resulting from the comparison of the target value and actual value of the yaw rate variable is evaluated.

13. The agricultural vehicle combination of claim 12, wherein the control unit, upon identification of an expected oversteer or understeer tendency of the agricultural tractor, preloads the wheel braking devices of the trailer to a defined grinding point.

14. The agricultural vehicle combination of claim 8, wherein the steering angle is derived by the control unit on the basis of a steering angle variable detected by a steering angle sensor, which reflects a wheel steering angle set at steerable wheels of the agricultural tractor or an unequivocally related substitute variable.

15. An agricultural vehicle combination including an agricultural tractor and a trailer attached thereto, comprising:
a sensor array assigned to the agricultural tractor, and
a control unit configured to receive signals from the sensor array, to determine an actual value of a yaw rate variable characterizing a yaw rate of the agricultural tractor, and to compare the actual value of the yaw rate variable with a target value specified for the yaw rate variable for identifying an oversteer or understeer tendency of the agricultural tractor,
wherein the specification of the target value by the control unit takes place so as to correspond to a yaw behavior to be expected due to the steering angle and the traveling speed of the agricultural tractor,
wherein the control unit, upon identification of an understeer tendency of the agricultural tractor arising in trailer operation, is configured to conclude that this is a retarded articulation angle reduction caused by thrust, and at least partially compensates for this by driver-independent intervention in wheel braking devices of the trailer.
